(19) United States
(12) Patent Application Publication
(10) Pub. No.: US 2025/0045636 A1
(43) Pub. Date: Feb. 6, 2025

(54) DATA SAMPLING USING LOCALITY SENSITIVE HASHING FOR LARGE SCALE GRAPH LEARNING

(71) Applicant: Google LLC, Mountain View, CA (US)

(72) Inventors: Sarath Shekkizhar, Seattle, WA (US); Mohamed Soliman Ahmed Soliman Farghl, Munich (DE); Animesh Nandi, Cupertino, CA (US); Mohammadhossein Bateni, Gillette, NJ (US); Sasan Tavakkol, Irvine, CA (US); Neslihan Bulut, Mountain View, CA (US)

(21) Appl. No.: 18/794,578

(22) Filed: Aug. 5, 2024

Related U.S. Application Data
(60) Provisional application No. 63/517,869, filed on Aug. 4, 2023.

(51) Int. Cl. G06N 20/00; G06F 16/901

(52) U.S. Cl. CPC G06N 20/00; G06F 16/9014

(57) ABSTRACT

A method and systems are disclosed for data sampling using locality sensitive hashing. Training data set comprising a plurality of data points is received. Each data point of the plurality of data points is assigned to a hash bucket of a set of hash buckets associated with a set of hash functions. A sample set of data points is generated by sampling data points from each bucket of the set of hash buckets. Each sample data point pair comprises a pair of data points from the sample set of data points. An artificial intelligence (AI) model to output a numerical value that produces a degree of similarity between an input pair of data points is trained using the plurality of sample data point pairs. A data structure representing relationships between data points of the plurality of data points is generated using the trained AI model and the training data set.

### RELATED APPLICATIONS

This non-provisional application claims priority to U.S. Provisional Patent Application No. 63/517,869 filed on Aug. 4, 2023, and entitled “DATA SAMPLING USING LOCALITY SENSITIVE HASHING FOR LARGE SCALE GRAPH LEARNING,” which is incorporated by reference herein.

### TECHNICAL FIELD

Aspects and implementations of the present disclosure relate to data sampling using locality sensitive hashing.

### BACKGROUND

Graph-based data analysis has become an increasingly vital tool in extracting valuable insights from complex and interconnected datasets. As the volume and complexity of data continue to grow across various domains, ranging from social networks and recommendation systems to bioinformatics and supply chain management, the demand for advanced techniques to analyze and interpret graph-structured data has surged.

### SUMMARY

The below summary is a simplified summary of the disclosure in order to provide a basic understanding of some aspects of the disclosure. This summary is not an extensive overview of the disclosure. It is intended neither to identify key or critical elements of the disclosure, nor to delineate any scope of the particular implementations of the disclosure or any scope of the claims. Its sole purpose is to present some concepts of the disclosure in a simplified form as a prelude to the more detailed description that is presented later.

An aspect of the disclosure provides a method for data sampling using locality sensitive hashing. The method includes receiving a training data set comprising a plurality of data points, each data point comprising a set of features. The method includes assigning each data point of the plurality of data points to a hash bucket of a set of hash buckets associated with a set of hash functions. The method includes generating a sample set of data points by sampling data points from each bucket of the set of hash buckets. The method includes generating a plurality of sample data point pairs, wherein each sample data point pair comprises a pair of data points from the sample set of data points. The method includes training, using the plurality of sample data point pairs, an artificial intelligence (AI) model to output a numerical value that produces a degree of similarity between an input pair of data points. The method includes generating, using the trained AI model and the training data set, a data structure representing relationships between data points of the plurality of data points.

Another aspect of the disclosure provides a system for data sampling using locality sensitive hashing. The system includes a memory and one or processing devices coupled to the memory and configured to perform one or more operations. The operations include receiving, by the processing device, a training data set comprising a plurality of data points, each data point comprising a set of features. The operations include assigning each data point of the plurality of data points to a hash bucket of a set of hash buckets associated with a set of hash functions. The operations include generating a sample set of data points by sampling data points from each bucket of the set of hash buckets. The operations include generating a plurality of sample data point pairs, wherein each sample data point pair comprises a pair of data points from the sample set of data points. The operations include training, using the plurality of sample data point pairs, an artificial intelligence (AI) model to output a numerical value that produces a degree of similarity between an input pair of data points. The operations include generating, using the trained AI model and the training data set, a data structure representing relationships between data points of the plurality of data points.

Another aspect of the disclosure provides a non-transitory machine-readable storage medium for data sampling using locality sensitive hashing. The system non-transitory machine-readable storage medium stores instructions which cause a processing device to perform operations. The operations include receiving, by a processing device, a training data set comprising a plurality of data points, each data point comprising a set of features. The operations include assigning each data point of the plurality of data points to a hash bucket of a set of hash buckets associated with a set of hash functions. The operations include generating, for each data point of the plurality of data points, a list of hash buckets associated with the set of hash functions applied to a respective data point. The operations include generating a plurality of sample data point pairs, wherein each sample data point pair comprises a pair of data points from the plurality of data points. The operations include training, using the plurality of sample data point pairs, an artificial intelligence (AI) model to output a numerical value that produces a degree of similarity between an input pair of data points. The operations include generating, using the trained AI model and the training data set, a data structure representing relationships between data points of the plurality of data points.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example system architecture, in accordance with implementations of the present disclosure.

FIG. 2 illustrates an example predictive system, in accordance with implementations of the present disclosure.

FIG. 3 illustrates an example training set generator of the predictive system of FIG. 2, in accordance with implementations of the present disclosure.

FIG. 4A illustrates an example partitioning of a hyperspace of a dataset, in accordance with implementations of the present disclosure.

FIG. 4B illustrates an example hash table for the partitioned hyperspace of FIG. 4A, in accordance with implementations of the present disclosure.

FIG. 5 depicts a flow diagram illustrating an example method for data sampling using locality sensitive hashing, in accordance with implementations of the present disclosure.

FIG. 6 depicts a flow diagram illustrating another example method for data sampling using locality sensitive hashing, in accordance with implementations of the present disclosure.

FIG. 7 is a block diagram illustrating an exemplary computer system, in accordance with implementations of the present disclosure.

### DETAILED DESCRIPTION OF THE DRAWINGS

Aspects of the present disclosure generally relate to data sampling using locality sensitive hashing. Graphs are data structures that provide a versatile framework for representing relationships, dependencies, and interactions among high-dimensional data, making them an ideal choice for applications spanning social networks, recommendation systems, natural language processing, and beyond. High-dimensional data refers to a collection of data points (e.g., dataset) having a large number of features or attributes associated with each data point. A fundamental step in graph-based methods is the construction or learning of a similarity graph from the collection of data points. The similarity graph is a network-like data structure where nodes represent individual data points of the collection of data points, and weighted edges denote the degree of similarity between pairs of data points. By encapsulating pairwise similarity relationships across the entire dataset, the similarity graph forms the foundation for various graph-based analysis and machine learning tasks. In some implementations, the choice of similarity measure for constructing similarity graphs is often arbitrary when selecting similarity metrics which can lead to suboptimal similarity graphs, potentially compromising the effectiveness of subsequent analyses.

To address the challenges of arbitrary similarity choices in graph construction, a learned graph construction procedure (e.g., Grale) introduce a data-driven approach. The learned graph construction procedure may involve two steps: (1) training a similarity neural network (e.g., model) on available labeled data (e.g., training step), and (2) constructing a similarity graph for the entire dataset using this learned similarity model (e.g., construction step). The learned graph construction procedure aims to create more informative and task-relevant graph structures, particularly in semi-supervised settings.

In some implementations, the learned graph construction procedure uses data structures from nearest-neighbor search literature, such as locality sensitive hashing (LSH), to efficiently limit the similarity model training and graph construction to relevant pairs of data points. LSH consist of a family of hash functions that map two points to the same hash bucket or value when the two points are similar. In other words, LSH efficiently groups similar items into the same bucket allowing for rapid approximate nearest neighbor search in high-dimensional spaces.

Despite the efficiency gains provided by LSH, with extremely large datasets (e.g., datasets containing billions of points), the training step of the learned graph construction procedure may still involve an even larger number of edges (e.g., trillions of edges), resulting in extensive computational requirements and training times. Thus, the computational burden severely limits the practical applicability of the learned graph construction procedure. As datasets continue to grow, it has become evident that relying solely on LSH for training similarity models is insufficient. Given limited computational resources or time, there is a need for the learned graph construction procedure to provide a summarized view of the dataset (e.g., by sampling a small subset of the dataset) for efficient learning of the similarity models.

Sampling techniques typically prioritize the selection of diverse data points, thereby avoiding the selection of similar points together. However, the samples in the graph learning setting need to be representative of the data distribution while also capturing highly similar points (edges) for obtaining a similarity graph representative of the entire dataset. These sample techniques struggle with scalability in large datasets due to the increase memory usage and computational requirements. Thus, for extremely large datasets, some sampling techniques randomly partition the dataset and sample within each partition. However, this approach risks discarding important information and relationships between data points in different partitions. In some implementations, randomly sampling the dataset, while computationally efficient, may not adequately capture the underlying data distribution, potentially missing important similarities between data points and leading to suboptimal graph construction.

Sampling techniques often prioritizes diverse data points, avoiding similar ones. However, in graph learning, capturing similar points is essential to creating an accurate graph of the entire dataset. Current sampling methods struggle with large datasets because they require more memory and computing power as the dataset size grows. Some sampling techniques manage this by splitting the dataset into smaller parts and sampling within each part. This approach, however, can miss important connections between data points in different parts.

Aspects of the present disclosure address the above and other deficiencies by sampling, based on locality sensitive hashing of the dataset, data points of the dataset to be used in training a similarity model. Given a family of predefined LSH functions, a subset of the family of predefined LSH functions (e.g., set of hash functions) is randomly selected and applied to each data point of the dataset. Each data point in the dataset is then sketched or bucketed into multiple hash tables, with one hash table corresponding to each hash function of the set of hash functions. Specifically, for each hash function a data point is assigned to a bucket in the corresponding hash table based on its hash value produced by a respective hash function. As a result, each data point being is represented across multiple hash tables. The buckets across the multiple hash tables represent a set of buckets for sampling. In some implementations, any bucket in the set of buckets for sampling containing a number of data points that exceeds a predetermined bucket threshold is randomly subdivided. The predetermined bucket threshold is a numerical value indicating a maximum number of data points for each bucket. Accordingly, during sampling the subdivided buckets may be used to select more data points for larger buckets, or the sampling may be dispersed between the subdivided buckets to align with further down sampling of the data points within buckets.

In some implementations, a bucket-level metric is calculated for each bucket in the set of buckets for sampling. The bucket-level metric of each bucket in the set of buckets for sampling are compared to a predetermined bucket metric threshold. Each bucket that does not satisfy the predetermined bucket metric threshold is removed (or filtered out) from the set of buckets for sampling.

The bucket-level metric may include, for example, bucket size, bucket occupancy rate, collision rate, data point distribution, empty bucket ratio, maximum bucket size, minimum bucket size, average chain length, bucket similarity, inter-bucket distances, load factor, etc. Bucket size refers to the number of data points in each bucket. Bucket occupancy rate represents the proportion of non-empty buckets. Collision rate measures the average number of data points per non-empty bucket. Data point distribution refers to a histogram of bucket sizes. Empty bucket ratio refers to the proportion of buckets containing no data points. Maximum bucket size refers to the size of the largest bucket. Minimum bucket size refers to the size of the smallest non-empty bucket. Average chain length, relevant for chained hash tables, refers to the average number of items in collision chains. Bucket similarity quantifies how similar items within the same bucket are. Inter-bucket distance refers to the average distance or dissimilarity between items in different buckets. Load factor refers to the ratio of the total number of stored items to the number of buckets.

In some implementations, a predetermined number of unique data points are randomly selected across the set of buckets (e.g., from each bucket of the set of buckets) for sampling and included in a sample set of data points. In other words, if a currently selected data point from a current bucket is present in the sample set of data points, another data point from the current bucket is randomly selected to be included in the sample set of data points.

In other implementations, a predetermined number of data points are randomly selected from a LSH similarity graph and included in the sample set of data points. As described above, each data point is sketched or hashed into a bucket across multiple hash tables. The LSH similarity graph is constructed by obtaining, for each data point, a list of buckets across multiple hash tables, specifically the buckets in each hash table in which a respective data point was sketched or hashed into. For each pair of data points in the dataset, a LSH similarity score is calculated. The LSH similarity score is a numerical value that represents a degree of similarity between the list of buckets of a respective pair of data points. In some implementations, the LSH similarity score is calculated using Jaccard similarity. During construction of the LSH similarity graph, each data point of the dataset represents a node in the LSH similarity graph and each LSH similarity score between pairs of data points in the dataset represents a weighted edge in the LSH similarity graph between nodes corresponding to the pairs of data points. A subset of nodes in the LSH similarity graph is randomly selected such that the weighted edges between each of the selected predetermined number of nodes is less than a predetermined LSH similarity threshold indicating that the predetermined number of nodes are not highly similar to one another.

For each pair of data points in the sample set of data points, a feature similarity score is calculated. The feature similarity score is a numerical value that represents a degree of similarity between features of a respective pair of data points. In some implementations, the feature similarity score is calculated using cosine similarity, Euclidean distance, Jaccard similarity, or other suitable similarity metric. The feature similarity score of each pair of data points is compared to a predetermined feature similarity threshold. If the feature similarity score of a pair of data points exceeds the predetermined feature similarity threshold, a weighted edge is created between the pair of data points and included in a set of training edges.

Using the set of training edges, an artificial intelligence (AI) model is trained to predict a feature similarity score between the input pairs. The trained machine learning (e.g., a trained similarity model) is subsequently used to predict feature similarity scores for each pair of data points of the dataset. For each pair of data points of the dataset having a feature similarity score exceeding the predetermined feature similarity threshold, a corresponding weighted edge is created. During construction of the similarity graph, each data point of the dataset represents a node in the similarity graph and pairs of nodes are linked in the similarity graph by their corresponding weighed edge.

Accordingly, aspects of the present disclosure cover techniques that leverage locality sensitive hashing as an adaptive partition of the input dataset to sample diverse and highly similar points, thereby significantly reducing the run time and memory requirements of a training procedure while producing accurate graph representations and improved clustering results.

Simply, the technical problem in graph-based analysis of high-dimensional data is the efficient construction of informative similarity graphs for extremely large datasets. Specifically, the learned graph construction procedure, which aims to create more task-relevant graph structures, faces significant computational challenges when dealing with billions of data points, potentially resulting in trillions of edges. Traditional sampling techniques, which prioritize diversity, are not ideal for this context as they may miss similarities between data points. The technical solution in the learned graph construction of graph-based analysis of high-dimensional data leverages LSH as an adaptive partition of the input dataset to sample both diverse and representative of highly similar data points.

Implementation of the present disclosure can be applied to a wide range of applications, and, in particular, to improve a trust model which detects a significant amount (e.g., hundreds of millions) of risky accounts by constructing a similarity graph to detect coordinated scaled abuse (e.g., in a cloud based environment) and understand similarity between abusers.

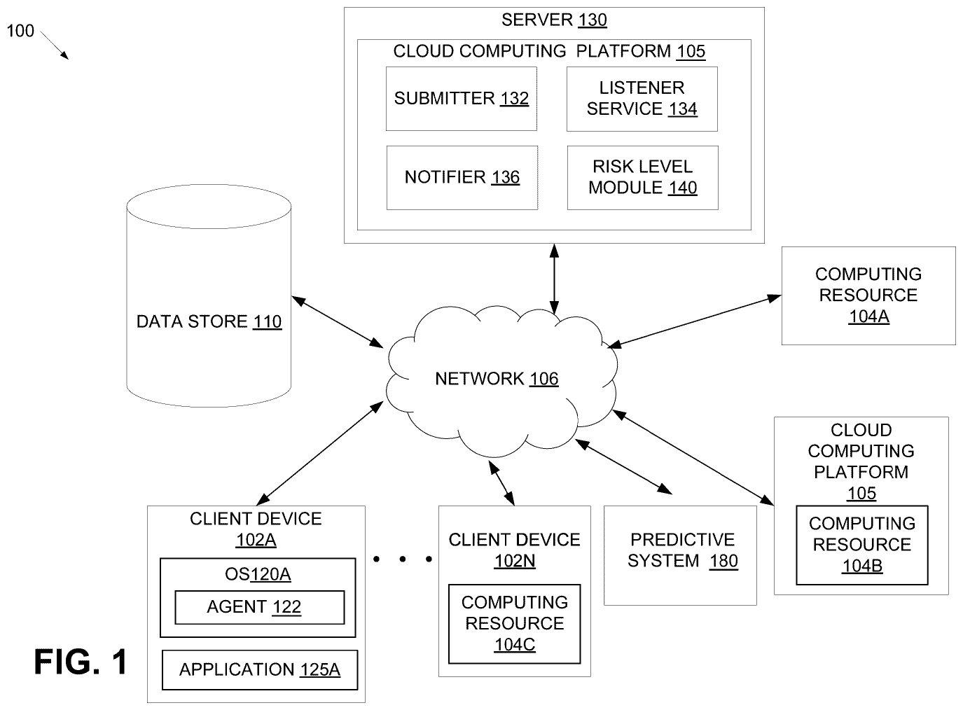

FIG. 1 illustrates an example system architecture 100, in accordance with at least one embodiment of the present disclosure. The system architecture 100 (also referred to as “system” herein) includes client devices 102A-N (collectively and individually referred to as client device 102 herein), computing resource 104A-C, cloud computing platform 105, a data store 110, a server 130, and/or a predictive system 180 each connected to a network 106. Note that while three computing resources 104A-C are illustrated in FIG. 1, system 100 is not limited to three computing resources 104A-C, and can include fewer or additional computing resources 104A-C. Network 106 can include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

Client devices 102A-N can each include computing devices such as personal computers (PCs), laptops, mobile phones, smart phones, tablet computers, netbook computers, network-connected televisions, digital assistants, servers, networking equipment, or any other computing devices. In some embodiments, client devices 102A-N can also be referred to as “user devices.” Client devices 102A-N can be used by users such as security professionals, owners and operators of computing resources 104A-C, and/or users accessing computing resources 104A-C. Client devices 102A-N can host a computing resource 104C, and/or can access a computing resource 104A-C. Computing resources 104A-C can be vulnerable to malicious intrusive activity.

In some embodiments, computing resources 104A-C can include one or more processing devices, volatile and non-volatile memory, data stored, one or more input/output peripherals such as network interfaces. In some embodiments, computing resources 104A-C can be singular devices such as smartphones, tablets, laptops, desktops, workstations, edge devices, embedded devices, servers, network appliances, security appliances, etc. In some embodiments, computing resources 104A-C can comprise multiple devices of similar or varying architecture such as computing clusters, data centers, co-located servers, enterprise networks, geographically disparate devices connected via virtual private networks (VPNs), etc. In some embodiments, computing resources 104A-C can comprise hardware devices such as those just described, virtual resources such as virtual machines (VMs) and containerized applications, or a combination of hardware and virtual resources. In some embodiments, computing resources can be associated with one or more entities. For example, an entity can own or lease hardware devices such as a server or a data center. In another example, a client entity can lease virtual resources (e.g., a VM) from a provider entity. The provider entity can provision the virtual resources (along with virtual resources associated with other client entities) on hardware devices that the provider entity owns or leases itself. In some embodiments, computing resources 104A-C can be accessible via an application, e.g., a web application.

In some embodiments, cloud computing platform 105 can enable users (e.g., of client devices 102A-N) to access and utilize various computing resources (e.g., computing resources 104A-C), e.g., via network 106. For example, a provider entity associated with cloud computing platform 105 can offer to lease computing resources 104A-C, such as hardware devices, virtual machines, etc. In some embodiments, computing resources 104A-C can be distributed across multiple hardware devices (e.g., within a data center or across disparate geographical locations) and can be communicatively connected via internal networks (not depicted), external networks such as network 106, or a combination thereof. The provider entity can include various users (e.g., security researchers and other professionals/employees) to manage the computing resources 104B of cloud computing platform 105. In some embodiments, submitter 132, listener service 134, and/or notifier 136 (and/or parts thereof) can be executed on cloud computing platform 105.

In some embodiments, data store 110 is a persistent storage that is capable of storing data as well as data structures to tag, organize, and index the data. Data store 110 can be hosted by one or more storage devices, such as main memory, magnetic or optical storage-based disks, tapes or hard drives, NAS, SAN, and so forth. In some embodiments, data store 105 can be a network-attached file server, while in other embodiments data store 110 can be some other type of persistent storage such as an object-oriented database, a relational database, and so forth, that can be hosted on or can be a component of server 130 or one or more different machines (e.g., via network 106). In some embodiments, data store 110 can be provided by a third-party service such as a cloud platform provider. In some embodiments, the data store 110 can store techniques and/or a detection log.

In some embodiments, server 130 can be a rackmount server, a router computer, a personal computer, a portable digital assistant, a mobile phone, a laptop computer, a tablet computer, a netbook, a desktop computer, a virtual machine, etc., or any combination of the above. Server 130 can include a submitter 132, a listener service 134, and/or a notifier 136. In some embodiments, submitter 132, listener service 134, and/or notifier 136 can be part of a security platform (not depicted).

In some embodiments, submitter 132 can generate one or more scripts that mimic malicious intrusive activity. Listener service 134 can be a component that is designed to monitor and receive incoming signals (e.g., messages or events) from various sources (e.g., from computing resources 104A-C). In some embodiments, the listener service 134 can identify whether a signal is associated with benign activity. If it is not benign, the listener service 134 can send a notification to the notifier 136. In some embodiments, notifier 136 can send a notification.

A user device 102A-N can include an operating system (e.g., OS 120A), and any number of applications (e.g., application 125A). In some embodiments, an agent 122 can run on an operating system 120A. Agent 122 can refer to a software component or program that performs specific tasks or functions on behalf of the operating system 120A. In some embodiments, agent 122 can include the risk level module, which can measure the risk level of the corresponding user device 102A. Agent 122 can have system-level permissions, and can detect device activity, e.g., by listening for device events and information. In some embodiments, security platform 105 can include risk module 140, which can monitor the device activity of the corresponding user device 102A-N to collect vulnerability-related metrics data.

It should be noted that although FIG. 1 illustrates submitter 132, listener service 134, notifier 136, and risk level module 140 as part of platform 105, in additional or alternative embodiments, submitter 132, listener service 134, notifier 136, and/or risk level module 140 can reside on one or more server machines that are remote from platform 105. It should be noted that in some other implementations, the functions of server 130 and/or platform 105 can be provided by a fewer number of machines. For example, in some implementations, components and/or modules of any of server 130 may be integrated into a single machine, while in other implementations components and/or modules of any of server 130 may be integrated into multiple machines. In addition, in some implementations, components and/or modules of any of server 130 may be integrated into platform 105.

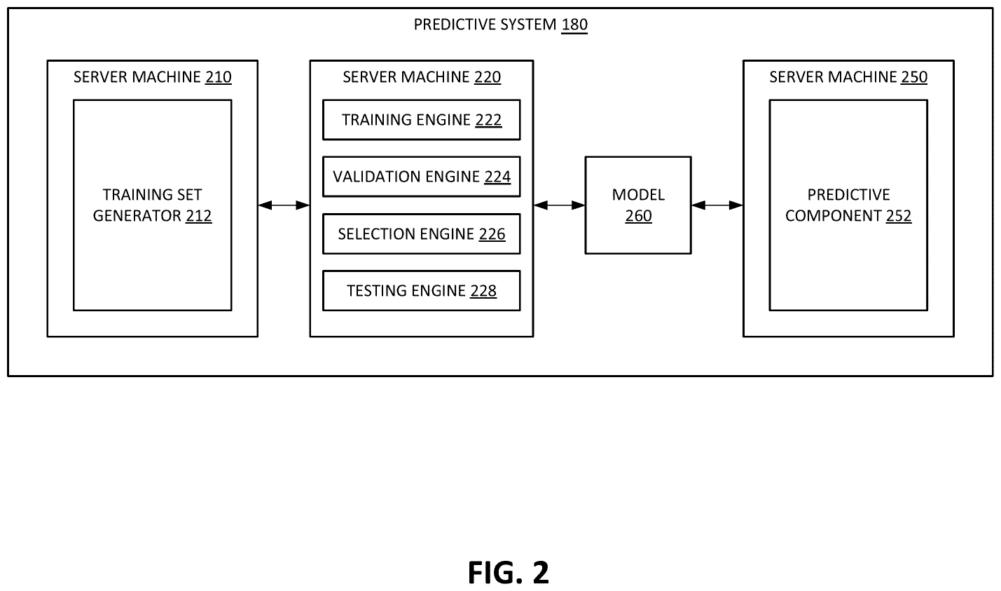

As illustrated in FIG. 1, system 100 can also include a predictive system 180, in some embodiments. Predictive system 180 can implement one or more artificial intelligence (AI) techniques (e.g., machine learning (ML)) for various operations of platform 105. In some embodiments, predictive system 180 can train an AI model (e.g., a machine learning model) to assist in the operations of platform 105. Further details regarding predictive system 180 are provided herein with respect to FIG. 2.

In general, functions described in implementations as being performed by platform 105 and/or server machine 130 can also be performed on the client devices 102A-N in other implementations. In addition, the functionality attributed to a particular component can be performed by different or multiple components operating together. Platform 105 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” In another example, an automated consumer can be an automated ingestion pipeline of platform 150.

In situations in which the systems discussed here collect personal information about users, or may make use of personal information, the users may be provided with an opportunity to control whether video conference platform 120 collects user information (e.g., information about a user's social network, social actions or activities, profession, a user's preferences, or a user's current location), or to control whether and/or how to receive content from the server 130 that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used.

FIG. 2 is a block diagram illustrating an exemplary predictive system 180, in accordance with implementations of the present disclosure. As illustrated in FIG. 2, predictive system 180 can include a training set generator 212 (e.g., residing at server machine 210), a training engine 212, a validation engine 224, a selection 226, and/or a testing engine 228 (e.g., each residing at server machine 220), and/or a predictive component 252 (e.g., residing at server machine 250). Training set generator 212 may be capable of generating training data (e.g., a set of training inputs and a set of target outputs) to train model 260.

In an illustrative example, training set generator 212 can generate training data for model 260. In such example, training set generator 212 can initialize a training set T to null (e.g., { }). Training set generator 212 can identify data to be included in the training dataset. In some embodiments, training set generator 212 can generate an input/output mapping based on the identified data. Training set generator 212 can add the input/output mapping to the training set T and can determine whether training set T is sufficient for model 260. Training set T can be sufficient for training if training set T includes a threshold amount of input/output mappings, in some embodiments. In response to determining that training set T is not sufficient for training, training set generator 212 can identify additional data and can generate additional input/output mappings based on the additional data. In response to determining that training set T is sufficient for training, training set generator 212 can provide training set T to train model 260 In some embodiments, training set generator 212 provides the training set T to training engine 222.

Training engine 222 can train an artificial intelligence model 260 using the training data (e.g., training set T) from training set generator 212. The model 260 can refer to the model artifact that is created by the training engine 222 using the training data that includes training inputs and/or corresponding target outputs (correct answers for respective training inputs). The training engine 222 can find patterns in the training data that map the training input to the target output (the answer to be predicted), and provide the model 260 that captures these patterns. The model 660 can be composed of, e.g., a single level of linear or non-linear operations (e.g., a support vector machine (SVM or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. For convenience, the remainder of this disclosure will refer to the implementation as a neural network, even though some implementations might employ an SVM or other type of learning machine instead of, or in addition to, a neural network. In one aspect, the training set is obtained by training set generator 212 hosted by server machine 210.

Validation engine 224 may be capable of validating a trained model 260 using a corresponding set of features of a validation set from training set generator 212. The validation engine 224 may determine an accuracy of each of the trained models 260 based on the corresponding sets of features of the validation set. The validation engine 224 may discard a trained model 260 that has an accuracy that does not meet a threshold accuracy. In some embodiments, the selection engine 226 may be capable of selecting a trained model 260 that has an accuracy that meets a threshold accuracy. In some embodiments, the selection engine 226 may be capable of selecting the trained model 260 that has the highest accuracy of the trained models 260.

The testing engine 228 may be capable of testing a trained model 260 using a corresponding set of features of a testing set from training set generator 212. For example, a first trained model 260 that was trained using a first set of features of the training set may be tested using the first set of features of the testing set. The testing engine 228 may determine a trained model 260 that has the highest accuracy of all of the trained models based on the testing sets.

Predictive component 252 of server machine 250 may be configured to feed data as input to model 260 and obtain one or more outputs. In additional or alternative embodiments, predictive component 252 can otherwise apply model 260 to data.

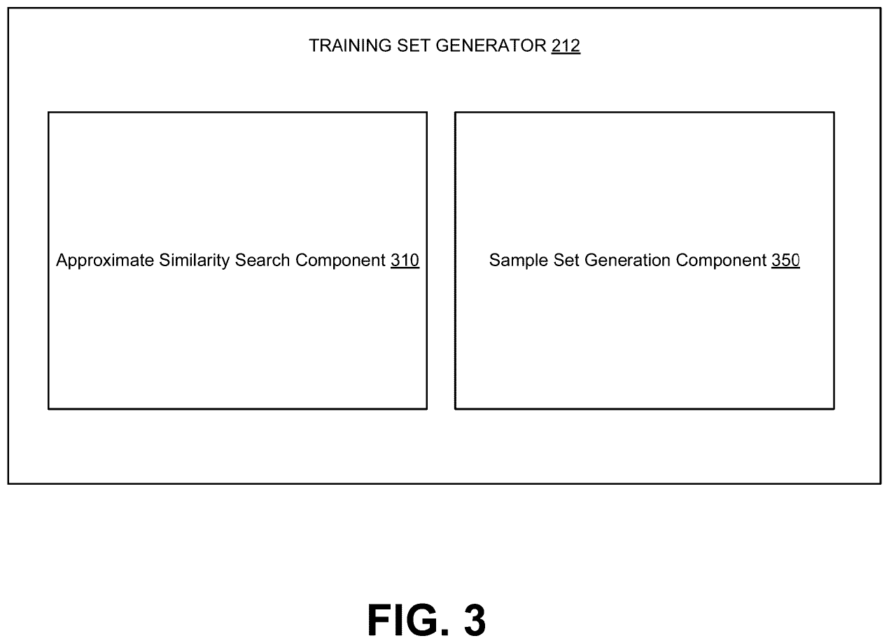

FIG. 3 is a block diagram illustrating an exemplary training set generator 212, in accordance with implementations of the present disclosure. As illustrated in FIG. 3, training set generator 212 can include an approximate similarity search component 310 and a sample set generation component 350. Training set generator 212 may receive a dataset (e.g., a plurality of data points) to generate training data. At least some data points in a plurality of data points may be associated with respective labels. A label may identify, e.g., a category (of a pre-defined set of categories) to which the data point belongs. In an illustrative example, the labels may be binary, i.e., they may refer to a classification system where each data point is assigned to one of two possible categories, typically represented as 0 and 1, −1 and 1, or Boolean values (e.g., true and false). For example, in email classification, messages might be labeled as spam (1) or not spam (0).

The approximate similarity search component 310 of the training set generator 212 inserts (e.g., sketches) each data point of the plurality of data points into a bucket. In an illustrative example, the approximate similarity search component 310 selects an appropriate family of LSH functions tailored to the similarity measure of the data, such that similar data points are more likely to hash to the same value. Parameters of the approximate similarity search component 310 are defined. For example, a number of hash tables (b) and a number of hash functions to be concatenated for each table (r). The approximate similarity search component 310 generates b composite hash functions, each formed by concatenating r randomly selected functions from the LSH family. Each of the b composite hash functions are used to construct b hash tables. For each data point in the dataset, the approximate similarity search component 310 applies all b composite hash functions, inserting the data point into the corresponding bucket (identified by a result of a corresponding composite hash function) in each of the b hash tables.

In some implementations, the approximate similarity search component 310 may identify each bucket in the b hash tables that satisfies a predetermined bucket threshold (e.g., overflowing bucket). A bucket satisfies the predetermined bucket threshold when a number of data points in the bucket exceeds the predetermined bucket threshold. The approximate similarity search component 310 subdivides each overflowing bucket. The approximate similarity search component 310 may subdivide the overflowing bucket by creating sub-buckets within the overflowing bucket of that particular hash table. Data points from the overflowing bucket are then redistributed, randomly, among these sub-buckets, maintaining the integrity of the LSH scheme for that specific hash table. An index structure is created within each hash table to link original buckets to their respective sub-buckets. The approximate similarity search component 310 updates each hash table to reflect both buckets and relevant sub-buckets across all b hash tables. The approximate similarity search component 310 may generates a comprehensive bucket set which includes all buckets and sub-buckets across all b hash tables.

In some implementations, the approximate similarity search component 310 may filter out one or more buckets from the comprehensive bucket set. As described above, the approximate similarity search component 310 calculates a bucket-level metric for each bucket of the comprehensive bucket set. The approximate similarity search component 310 identifies each bucket of the comprehensive bucket set that satisfies a predetermined bucket metric threshold. A bucket of the comprehensive bucket set satisfies the predetermined bucket metric threshold when a bucket-level metric of the bucket exceeds the predetermined bucket metric threshold. Each bucket of the comprehensive bucket that does not satisfy the predetermined bucket metric threshold is removed or filtered out of the comprehensive bucket set.

In some implementations, the sample set generation component 350 of the training set generator 212 receives, from the approximate similarity search component 310, the comprehensive bucket set to generate a set of training edges. In an illustrative example, the sample set generation component 350 samples, from each bucket of the comprehensive bucket set, a predetermined number of data points to include in a sample set of data points. In particular, for each bucket of the comprehensive bucket set, the sample set generation component 350 selects a data point from a respective bucket. The sample set generation component 350 determines whether the selected data point from the respective bucket is present in the sample set of data points. If the selected data point from the respective bucket is not present in the sample set of data points, the sample set generation component 350 includes the selected data point into the sample set of data points. Otherwise, if the selected data point from the respective bucket is present in the sample set of data points, the sample set generation component 350 discards the selected data point and selects a new data point from the respective bucket until a data point that is not present in the sample set of data points is selected. Once a data point that is not present in the sample set of data points is selected, the sample set generation component 350 includes the selected data point into the sample set of data points.

In some implementations, the sample set generation component 350 of the training set generator 212 receives, from the approximate similarity search component 310, a list of buckets for each data point from the dataset. For each pair of data points from the dataset, the sample set generation component 350 calculates a numerical value that represents a degree of similarity between the list of buckets (e.g., a LSH similarity score). The LSH similarity score is calculated using Jaccard similarity or any suitable similarity metric. Each pair of data points from the dataset refers to a unique pair of data points from the dataset. The sample set generation component 350 constructs, based on the dataset and the LSH similarity score between data points from the dataset, a LSH similarity graph. Each data point of the dataset represents a node in the LSH similarity graph and each LSH similarity score between pairs of data points from the dataset represents a weighted edge in the LSH similarity graph between nodes corresponding to the pairs of data points. The sample set generation component 350 randomly selects a predetermined number of nodes in the LSH similarity graph such that the weighted edges between each of the selected predetermined number of nodes is less than a predetermined LSH similarity threshold indicating that the predetermined number of nodes are not highly similar to one another.

The sample set generation component 350 generates, using the sample set of data points, a set of training edges. For each pair of data points from the sample set of data points, the sample set generation component 350 calculates a numerical value that represents a degree of similarity between aspects of a respective pair of data points (e.g., a feature similarity score). The feature similarity score is calculated using cosine similarity, Euclidean distance, Jaccard similarity, or any suitable similarity metric. Each pair of data points from the sample set of data points refers to a unique pair of data points from the sample set of data points. The sample set generation component 350 identifies pair of data points from the sample set of data points that satisfies a predetermined feature similarity threshold. A pair of data points from the sample set of data points satisfies the predetermined feature similarity threshold when a feature similarity score exceeds the predetermined feature similarity threshold. Each pair of data points from the sample set of data points that satisfies the predetermined feature similarity threshold is included with their corresponding feature similarity score (e.g., weighted edge) into set of training edges. As a result, the pair of data points represent training inputs and their corresponding feature similarity score (e.g., weighted edge) represents a corresponding target output (correct answer for respective training inputs).

In large-scale abuse-detection, a fraction (e.g., a 10%) of a large amount of data points (e.g., billions) (e.g., a dataset) are labeled. Each labeled data point belongs to a class of abusive items, due to policy violation, or a class of safe items (e.g., active, non-abusive, or verified). With a predetermined sample budget (e.g., 5%) of the input dataset equally split across data points labeled as abusive, safe, and unlabeled for training the similarity function (e.g., the LSH similarity graph). The LSH similarity graph obtained is used to detect coordinated scaled abuse (e.g., in a cloud based environment) and understand similarity between abusers.

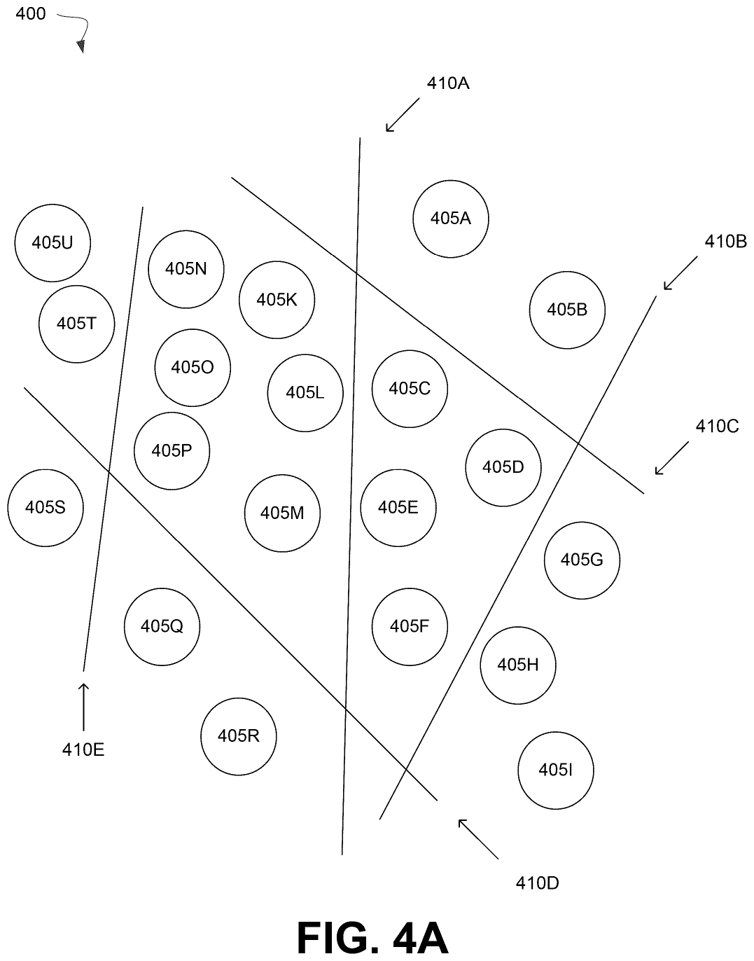

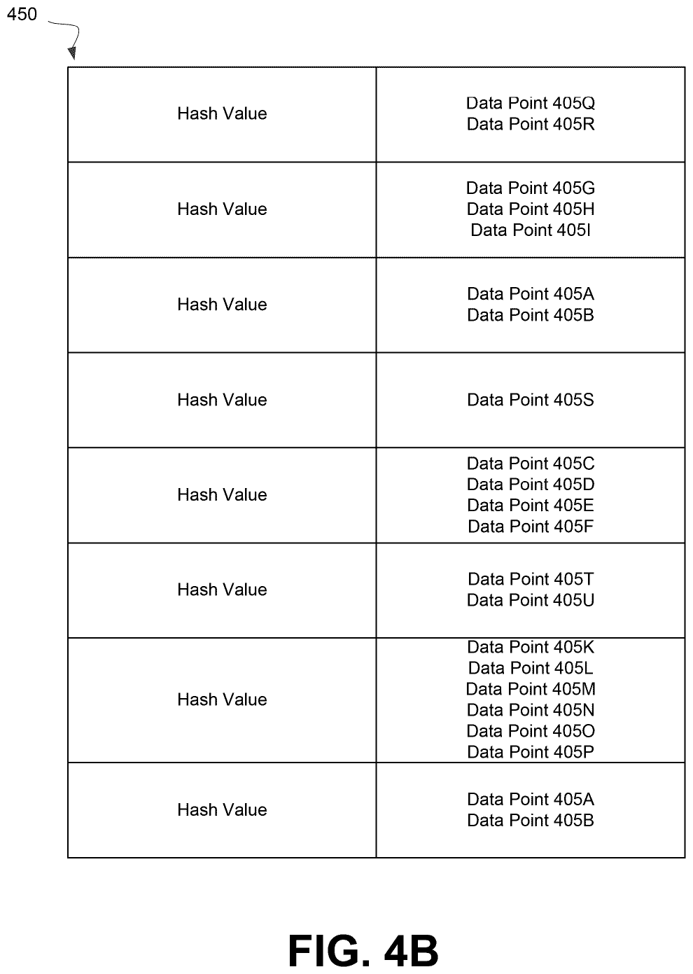

FIG. 4A illustrates partitioning of a hyperspace of a dataset created by a composite hash function of the b composite hash functions, in accordance with implementations of the present disclosure. Hyperspace 400 refers to an abstract mathematical space where each dimension of a multiple dimensions corresponds to a feature or attribute of data points 405A-U from the dataset. The hyperspace 400 may be divided into multiple regions referred to as buckets, by a series of hyperplanes 410A-E. Each hyperplane of the series of hyperplanes 410A-E, corresponding to a component of the composite hash function, separates the hyperspace 400 into two parts, effectively creating a binary decision for data points 405A-U represented as a bit of the hash value generated as a result of applying the composite hash function on the data points 405A-U. As a result, the data points 405A-U are either on one side of a respective hyperplane or the other. The combination of the series of hyperplanes 410A-E, which represent the composite hash function as a whole, creates multiple buckets. Each bucket can contain a subset of the data points 405A-U that share hash values and indicate their position relative to the series of hyperplanes 410A-E. With quick reference to FIG. 4B, which illustrates a hash table 450 including a plurality of entries. Each entry corresponds to a bucket generated by the series of hyperplanes 410A-E of FIG. 4A and includes a hash value identifying the bucket and the corresponding subset of the data points 405A-U that share the hash value.

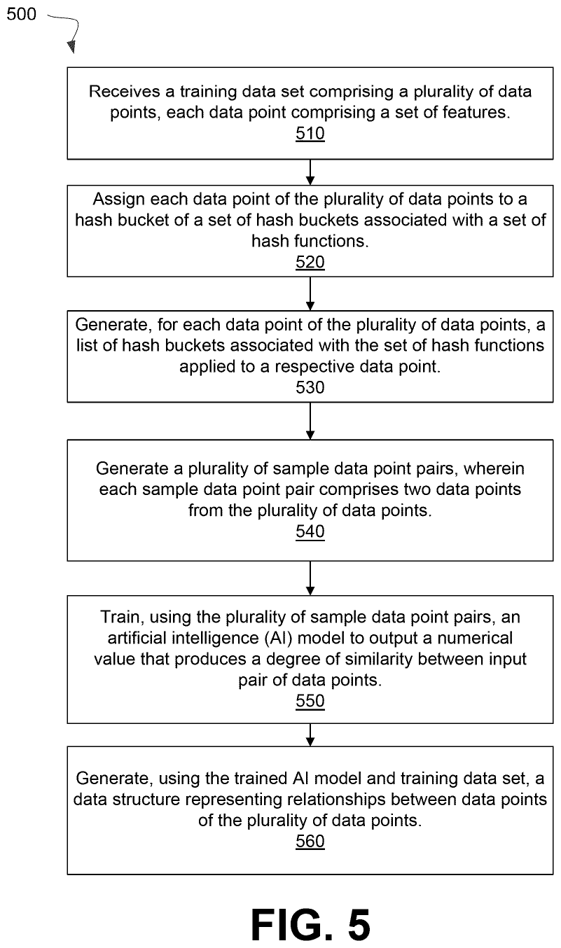

FIG. 5 depicts a flow diagram of a method 500 for data sampling using locality sensitive hashing, in accordance with implementations of the present disclosure. Method 500 may be performed by processing logic that may include hardware (circuitry, dedicated logic, etc.), software (e.g., instructions run on a processing device), or a combination thereof. In one implementation, some or all the operations of method 500 may be performed by one or more components of system 100 of FIG. 1 (e.g., platform 105, server 130, client device 102A-N, computing resource 104A, and/or cloud computing platform 105).

For simplicity of explanation, the method 500 of this disclosure is depicted and described as a series of acts. However, acts in accordance with this disclosure can occur in various orders and/or concurrently, and with other acts not presented and described herein. Furthermore, not all illustrated acts may be required to implement the method 500 in accordance with the disclosed subject matter. In addition, those skilled in the art will understand and appreciate that the method 500 could alternatively be represented as a series of interrelated states via a state diagram or events. Additionally, it should be appreciated that the method 500 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 510, the processing logic receives a training data set including a plurality of data points. Each data point can include a set of features. At block 520, the processing logic assigns each data point of the plurality of data points to a hash bucket of a set of hash buckets associated with a set of hash functions.

As previously described, each hash function in a set of composite hash functions (e.g., r-concatenated hash function) is used to partition a hyperspace, where each dimension represents a feature of data points. The hash function divides the space using hyperplanes, creating buckets. Each hyperplane contributes to a bit in the resulting hash value, effectively making a binary decision for each data point's position. Each hash value of an r-concatenated hash function is produced by concatenating values of a predefined number (r) of LSH functions selected from a family of LSH functions. This spatial partitioning can be mapped to a hash table, where each entry represents a bucket, its hash value, and the associated data points. In some implementations, the processing logic identifies and subdivides buckets that exceed a predetermined threshold of data points. It then creates sub-buckets within the identified buckets and randomly redistributes the data points among these sub-buckets.

At block 530, the processing logic generates a sample set of data points by sampling data points from each bucket of the set of hash buckets. As previously described, the processing logic samples a predetermined number of unique data points from each bucket, ensuring no duplicates are included in the sample set. If a selected data point is already in the sample set, the data point is discarded and a new data point is chosen until a unique one is found and added to the sample set.

At block 540, the processing logic generates a plurality of sample data point pairs. Each sample data point pair can include a pair of data points from the sample set of data points. As previously described, the plurality of sample data point pairs (e.g., set of training data point pairs) calculates for each unique pair of data points in the sample set of data points a degree of similarity (e.g., a feature similarity score). Each unique pair that whose degree of similarity (e.g., feature similarity score) exceed a predefined threshold (e.g., predetermined threshold) is included in the set of training data point pairs, with their scores serving as weighted data point pairs. These pairs and their corresponding scores form the training inputs and target outputs, respectively, for an AI model.

At block 550, the processing logic trains, using the plurality of sample data point pairs, an artificial intelligence (AI) model to output a numerical value that produces a degree of similarity between an input pair of data points. At block 550, the processing logic generates, using the trained AI model and the training data set, a data structure representing relationships between data points of the plurality of data points.

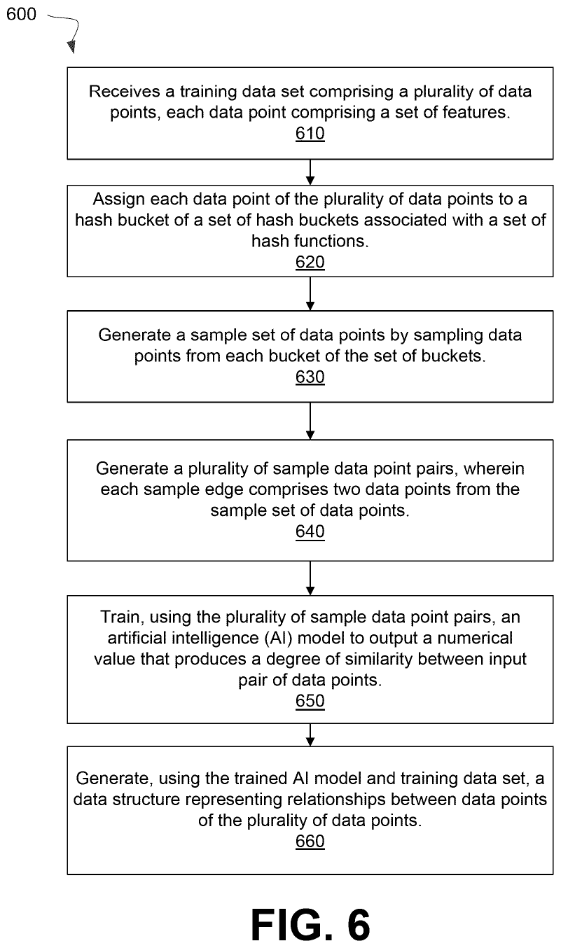

FIG. 6 depicts a flow diagram of a method 600 for data sampling using locality sensitive hashing, in accordance with implementations of the present disclosure. Method 600 may be performed by processing logic that may include hardware (circuitry, dedicated logic, etc.), software (e.g., instructions run on a processing device), or a combination thereof. In one implementation, some or all the operations of method 600 may be performed by one or more components of system 100 of FIG. 1 (e.g., platform 105, server 130, client device 102A-N, computing resource 104A, and/or cloud computing platform 105).

For simplicity of explanation, the method 600 of this disclosure is depicted and described as a series of acts. However, acts in accordance with this disclosure can occur in various orders and/or concurrently, and with other acts not presented and described herein. Furthermore, not all illustrated acts may be required to implement the method 600 in accordance with the disclosed subject matter. In addition, those skilled in the art will understand and appreciate that the method 600 could alternatively be represented as a series of interrelated states via a state diagram or events. Additionally, it should be appreciated that the method 600 disclosed in this specification is capable of being stored on an article of manufacture (e.g., a computer program accessible from any computer-readable device or storage media) to facilitate transporting and transferring such method to computing devices. The term “article of manufacture,” as used herein, is intended to encompass a computer program accessible from any computer-readable device or storage media.

At block 610, the processing logic receives a training data set including a plurality of data points. Each data point can include a set of features. At block 620, the processing logic assigns each data point of the plurality of data points to a hash bucket of a set of hash buckets associated with a set of hash functions.

As previously described, each hash function in a set of composite hash functions (e.g., r-concatenated hash function) is used to partition a hyperspace, where each dimension represents a feature of data points. The hash function divides the space using hyperplanes, creating buckets. Each hyperplane contributes to a bit in the resulting hash value, effectively making a binary decision for each data point's position. Each hash value of an r-concatenated hash function is produced by concatenating values of a predefined number (r) of LSH functions selected from a family of LSH functions. This spatial partitioning can be mapped to a hash table, where each entry represents a bucket, its hash value, and the associated data points. In some implementations, the processing logic identifies and subdivides buckets that exceed a predetermined threshold of data points. It then creates sub-buckets within the identified buckets and randomly redistributes the data points among these sub-buckets.

At block 630, the processing logic generates, for each data point of the plurality of data points, a list of hash buckets associated with the set of hash functions applied to a respective data point. As previously described, the processing logic for each pair of data points from the dataset, calculates a degree of similarity between a list of buckets associated with each data point of the pair of data points (e.g., a LSH similarity score). The processing logic then constructs a LSH similarity graph where each node represents a data point of the dataset represents and each LSH similarity score between pairs of data points for weighted data point pairs between them. Then, a predetermined number of nodes in the LSH similarity graph is randomly selected such that the weighted edges between each of the selected predetermined number of nodes is less than a predetermined LSH similarity threshold indicating that the predetermined number of nodes are not highly similar to one another.

At block 640, the processing logic generates a plurality of sample data point pairs. Each sample data point pair can include a pair of data points from the sample set of data points. As previously described, the plurality of sample data point pairs (e.g., set of training data point pairs) calculates for each unique pair of data points in the sample set of data points a degree of similarity (e.g., a feature similarity score). Each unique pair that whose degree of similarity (e.g., feature similarity score) exceed a predefined threshold (e.g., predetermined threshold) is included in the set of training data point pairs, with their scores serving as weighted data point pairs. These pairs and their corresponding scores form the training inputs and target outputs, respectively, for an AI model.

At block 650, the processing logic trains, using the plurality of sample data point pairs, an artificial intelligence (AI) model to output a numerical value that produces a degree of similarity between an input pair of data points. At block 550, the processing logic generates, using the trained AI model and the training data set, a data structure representing relationships between data points of the plurality of data points.

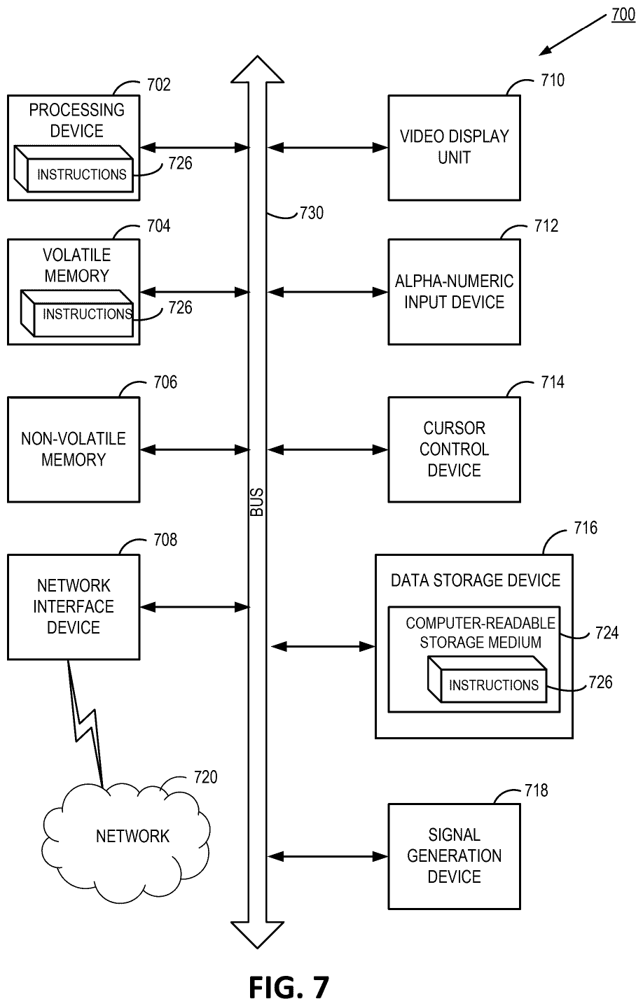

FIG. 7 is a block diagram illustrating an exemplary computer system 700, in accordance with implementations of the present disclosure. The computer system 700 can correspond to platform 105 and/or client devices 102A-N, described with respect to FIG. 1. Computer system 700 can operate in the capacity of a server or an endpoint machine in endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processing device (processor) 702, a main memory 704 (e.g., read-only memory (ROM), flash memory, dynamic random access memory (DRAM) such as synchronous DRAM (SDRAM), double data rate (DDR SDRAM), or DRAM (RDRAM), etc.), a static memory 706 (e.g., flash memory, static random access memory (SRAM), etc.), and a data storage device 718, which communicate with each other via a bus 740.

Processor (processing device) 702 represents one or more general-purpose processing devices such as a microprocessor, central processing unit, or the like. More particularly, the processor 702 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 702 can also be one or more special-purpose processing devices such as an application specific integrated circuit (ASIC), a field programmable gate array (FPGA), a digital signal processor (DSP), network processor, or the like. The processor 702 is configured to execute instructions 705 for performing the operations discussed herein.

The computer system 700 can further include a network interface device 708. The computer system 700 also can include a video display unit 710 (e.g., a liquid crystal display (LCD) or a cathode ray tube (CRT)), an input device 712 (e.g., a keyboard, and alphanumeric keyboard, a motion sensing input device, touch screen), a cursor control device 714 (e.g., a mouse), and a signal generation device 720 (e.g., a speaker).

The data storage device 718 can include a non-transitory machine-readable storage medium 724 (also computer-readable storage medium) on which is stored one or more sets of instructions 705 embodying any one or more of the methodologies or functions described herein. The instructions can also reside, completely or at least partially, within the main memory 704 and/or within the processor 702 during execution thereof by the computer system 700, the main memory 704 and the processor 702 also constituting machine-readable storage media. The instructions can further be transmitted or received over a network 730 via the network interface device 708.

In one implementation, the instructions 705 include instructions for performing the operations discussed herein. While the computer-readable storage medium 724 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Reference throughout this specification to “one implementation,” “one embodiment,” “an implementation,” or “an embodiment,” means that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics can be combined in any suitable manner in one or more implementations.

To the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a “device” can come in the form of specially designed hardware; generalized hardware made specialized by the execution of software thereon that enables hardware to perform specific functions (e.g., generating interest points and/or descriptors); software on a computer readable medium; or a combination thereof.

The aforementioned systems, circuits, modules, and so on have been described with respect to interact between several components and/or blocks. It can be appreciated that such systems, circuits, components, blocks, and so forth can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collect data is anonymized prior to performing any analysis to obtain any statistical patterns so that the identity of the user cannot be determined from the collected data.

What is claimed is:

1. A method comprising:
receiving, by a processing device, a training data set comprising a plurality of data points, each data point comprising a set of features;
assigning each data point of the plurality of data points to a hash bucket of a set of hash buckets associated with a set of hash functions;
generating a sample set of data points by sampling data points from each bucket of the set of hash buckets;
generating a plurality of sample data point pairs, wherein each sample data point pairs comprises two data points from the sample set of data points;
training, using the plurality of sample data point pair, an artificial intelligence (AI) model to output a numerical value that produces a degree of similarity between an input pair of data points; and
generating, using the trained AI model and the training data set, a data structure representing relationships between data points of the plurality of data points.

2. The method of claim 1, wherein sampling data points from a hash bucket of the set of hash buckets further comprises:
randomly selecting a data point of a subset of data points that are associated with the hash bucket and satisfy a predefined condition.

3. The method of claim 1, further comprising:
generating the set of hash functions by randomly selecting a predefined number of r-concatenated hash functions of a plurality of r-concatenated hash functions.

4. The method of claim 3, wherein a value of each r-concatenated hash function is produced by concatenating values of a predefined number (r) locality sensitive hashing (LSH) functions selected from a family of LSH functions.

5. The method of claim 1, wherein assigning each data point of the plurality of data points to a hash bucket of a set of hash buckets further comprises:
responsive to determining that a number of data points associated with the hash bucket exceeds a predefined threshold value, subdividing the hash bucket into two or more hash sub-buckets.

6. The method of claim 1, wherein a value of a hash function of a given data point comprises a plurality of bits, each bit indicating a position of the given data point with respect to a respective dividing hyperplane in a hyperspace of features that form the plurality of data points.

7. The method of claim 1, wherein data points of each data point pair of the plurality of data point pairs have at least a predefined threshold degree of similarity.

8. A system comprising:
a processing device to perform operations comprising:
receiving, by the processing device, a training data set comprising a plurality of data points, each data point comprising a set of features;
assigning each data point of the plurality of data points to a hash bucket of a set of hash buckets associated with a set of hash functions;
generating a sample set of data points by sampling data points from each bucket of the set of hash buckets;
generating a plurality of sample data point pairs, wherein each sample data point pair comprises a pair of data points from the sample set of data points;
training, using the plurality of sample data point pairs, an artificial intelligence (AI) model to output a numerical value that produces a degree of similarity between an input pair of data points; and
generating, using the trained AI model and the training data set, a data structure representing relationships between data points of the plurality of data points.

9. The system of claim 8, wherein sampling data points from a hash bucket of the set of hash buckets further comprises:
randomly selecting a data point of a subset of data points that are associated with the bucket and satisfy a predefined condition.

10. The system of claim 8, wherein the processing device is to perform operations further comprising:
generating the set of hash functions by randomly selecting a predefined number of r-concatenated hash functions of a plurality of r-concatenated hash function.

11. The system of claim 10, wherein a value of each r-concatenated hash function is produced by concatenating values of a predefined number (r) locality sensitive hashing (LSH) functions selected from a family of LSH functions.

12. The system of claim 8, wherein assigning each data point of the plurality of data points to a hash bucket of a set of hash buckets further comprises:
responsive to determining that a number of data points associated with the hash bucket exceeds a predefined threshold value, subdividing the hash bucket into two or more hash sub-buckets.

13. The system of claim 8, wherein a value of a hash function of a given data point comprises a plurality of bits, each bit indicating a position of the given data point with respect to a respective dividing hyperplane in a hyperspace of features that form the plurality of data points.

14. The system of claim 8, wherein the pair of data points has at least a predefined threshold degree of similarity.

15. A non-transitory machine-readable storage medium storing instructions which, when executed, cause a processing device to perform operations comprising:
receiving, by a processing device, a training data set comprising a plurality of data points, each data point comprising a set of features;
assigning each data point of the plurality of data points to a hash bucket of a set of hash buckets associated with a set of hash functions;
generating, for each data point of the plurality of data points, a list of hash buckets associated with the set of hash functions applied to a respective data point;
generating a plurality of sample data point pairs, wherein each sample data point pair comprises a pair of data points from the plurality of data points;
training, using the plurality of sample data point pairs, an artificial intelligence (AI) model to output a numerical value that produces a degree of similarity between an input pair of data points; and
generating, using the trained AI model and the training data set, a data structure representing relationships between data points of the plurality of data points.

16. The non-transitory machine-readable storage medium of claim 15, further comprising:
generating the set of hash functions by randomly selecting a predefined number of r-concatenated hash functions of a plurality of r-concatenated hash function.

17. The non-transitory machine-readable storage medium of claim 16, wherein a value of each r-concatenated hash function is produced by concatenating values of a predefined number (r) locality sensitive hashing (LSH) functions selected from a family of LSH functions.

18. The non-transitory machine-readable storage medium of claim 15, wherein assigning each data point of the plurality of data points to a hash bucket of a set of hash buckets further comprises:
responsive to determining that a number of data points associated with the hash bucket exceeds a predefined threshold value, subdividing the hash bucket into two or more hash sub-buckets.

19. The non-transitory machine-readable storage medium of claim 15, wherein a value of a hash function of a given data point comprises a plurality of bits, each bit indicating a position of the given data point with respect to a respective dividing hyperplane in a hyperspace of features that form the plurality of data points.

20. The non-transitory machine-readable storage medium of claim 15, wherein the pair of data points has at least a predefined threshold degree of similarity.
